(19) United States
(12) Patent Application Publication
(10) Pub. No.: US 2024/0246251 A1
(43) Pub. Date: Jul. 25, 2024

(54) SHAVING BLADE

(71) Applicant: DORCO CO., LTD., Yongin-si (KR)

(72) Inventors: Hyun Kyu JUNG, Yongin-si (KR); Min Joo PARK, Yongin-si (KR); Myoung Jin KIM, Seoul (KR); Seong Won JEONG, Yongin-si (KR)

(21) Appl. No.: 18/628,174

(22) Filed: Apr. 5, 2024

Related U.S. Application Data
(63) Continuation of application No. PCT/KR2022/014899, filed on Oct. 4, 2022.

(30) Foreign Application Priority Data
Oct. 7, 2021 (KR) 10-2021-0133084

(51) Int. Cl. B26B 21/56; B26B 21/60

(52) U.S. Cl. CPC B26B 21/56; B26B 21/60

(57) ABSTRACT

A razor blade is proposed. The razor blade may include a substrate including a substrate edge having a substrate tip formed at an end portion thereof. The razor blade may also include a coating layer disposed on the substrate and having a coating tip formed at the end portion thereof. The coating layer may include a pair of first facets extending from the coating tip and a pair of second facets extending from the pair of first facets. A gradient of the first facet may be smaller than that of the second facet based on a reference line passing through the substrate tip and the coating tip.

### CROSS-REFERENCE TO RELATED APPLICATIONS

This is a continuation application of International Patent Application No. PCT/KR2022/014899 filed on Oct. 4, 2022, which claims priority to Korean Patent Application No. 10-2021-0133084 filed on Oct. 7, 2021, the contents of each of which are incorporated by reference herein in their entirety.

### BACKGROUND

### Technical Field

The present disclosure relates to a shaving blade or razor blade.

### Description of Related Technology

A shape of a razor blade plays an important role in the quality of shaving. In particular, a shape of a cutting edge included in the razor blade significantly affects a cutting force of the razor blade. Here, the cutting force refers to a force required for the razor blade to cut a single hair.

### SUMMARY

One aspect is a razor blade with a shape that can minimize skin irritation while reducing a cutting force.

Another aspect is a razor blade, comprising: a substrate including a substrate edge having a substrate tip formed at an end portion thereof; and a coating layer disposed on the substrate and having a coating tip formed at the end portion thereof, wherein the coating layer includes: a pair of first facets extending from the coating tip; and a pair of second facets extending from the pair of first facets, and wherein a gradient of the first facet is smaller than that of the second facet based on a reference line passing through the substrate tip and the coating tip.

According to at least one of disclosed embodiments, there is an effect of minimizing skin irritation while simultaneously reducing a cutting force.

### BRIEF DESCRIPTION OF THE DRAWINGS

FIG. 1 is a diagram and a partial enlarged view illustrating a schematic profile of a razor blade according to an embodiment of the present disclosure.

FIG. 2 is a diagram for describing angles formed by each facet in the profile of FIG. 1.

FIG. 3 is a diagram for describing formation positions and thicknesses of each facet in the profile of FIG. 1.

FIGS. 4A and 4B are diagrams illustrating hair and results of a cutting force test on the hair.

### DETAILED DESCRIPTION

An area that significantly affects the cutting force is an area substantially adjacent to a tip of the cutting edge. When a shape of the area adjacent to the tip of the cutting edge is relatively sharp, the cutting force is reduced, so a user may easily cut the hair with less force but skin irritation may increase and cause injuries to the skin may occur.

On the other hand, when the shape of the area adjacent to the tip of the cutting edge is relatively blunt, the cutting force increases, so the user should apply more force to cut the hair, which may result in a less clean shave, but reduce the skin irritation and lower the possibility of causing injury.

Meanwhile, the traditional razor blade has a facet formed with a constant gradient from a tip of a coating layer disposed on a substrate to the vicinity of a tip of the substrate. Therefore, a sharpness of the cutting edge is determined by the gradient of the facet, and the cutting force and the degree of skin irritation are also determined according to the sharpness as described above, making it difficult to reduce both the cutting force and the skin irritation.

Accordingly, there is a need for a shape of a cutting edge capable of reducing both cutting force and skin irritation.

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related well-known configurations or functions when considered to obscure the subject of the present disclosure may be omitted for the purpose of clarity and for brevity.

Additionally, various ordinal numbers or alpha codes such as first, second, i), ii), a), b), etc., may be prefixed. These numbers and codes are solely used to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

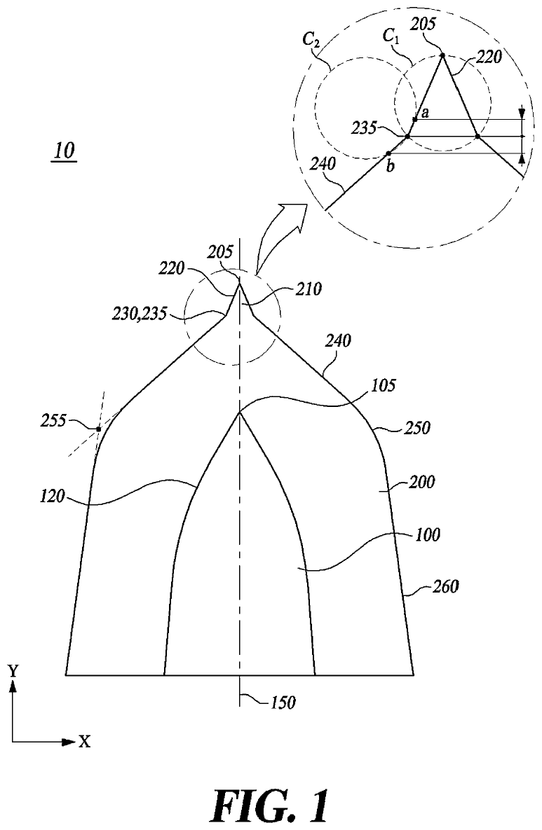

FIG. 1 is a diagram and a partial enlarged view illustrating a schematic profile of a razor blade according to an embodiment of the present disclosure.

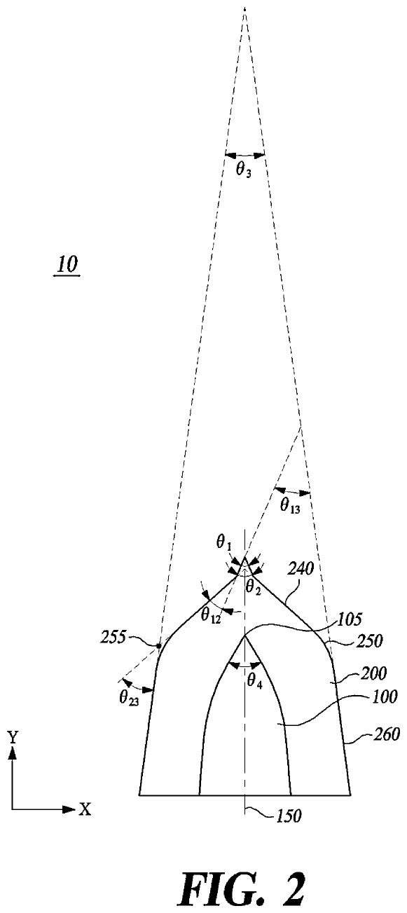

FIG. 2 is a diagram for describing angles formed by each facet in the profile of FIG. 1.

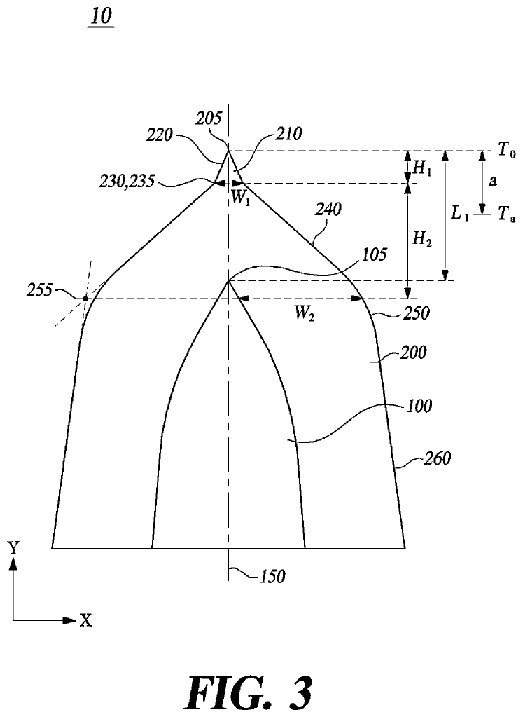

FIG. 3 is a diagram for describing formation positions and thicknesses of each facet in the profile of FIG. 1.

Referring to FIGS. 1 to 3, a razor blade 10 according to an embodiment of the present disclosure may include a substrate 100 and a coating layer 200.

The substrate 100 includes a substrate edge 120 and may be made of any one of stainless steel, carbon steel, and ceramics, but is not necessarily limited thereto.

A substrate tip 105 is formed at an end portion of the substrate edge 120. Accordingly, the substrate edge 120 may extend from the substrate tip 105 to both sides at a predetermined angle θ₄.

The coating layer 200 is disposed on the substrate 100, and a coating tip 205 is formed at an end portion of the coating layer 200. The coating layer 200 may include at least one metal or ceramic material such as Cr, C, B, Ti, etc.

In addition, the coating layer 200 may include a pair of first facets 220, a pair of second facets 240, and a pair of third facets 260. Meanwhile, hereinafter, a line passing through the substrate tip 105 and the coating tip 205 is defined as a reference line 150. For example, as illustrated in FIGS. 1 to 3, the reference line 150 may be in a direction parallel to the Y axis.

In addition, it is assumed that the first facet 220, the second facet 240, and the third facet 260 described below are formed in pairs.

The first facet 220 extends from the coating tip 205. Accordingly, the first facet 220 may extend symmetrically to the reference line 150 from the coating tip 205 to both sides.

The second facet 240 extends from the first facet 220. Accordingly, the second facet 220 may extend symmetrically to the reference line 150 from one end of the first facet 220.

An area where the first facet 220 and the second facet 240 meet, that is, an area where an extension of the first facet 220 ends and an extension of the second facet 240 begins, is defined as a first variant portion 230. Since the first facet 220 extends from the coating tip 205 to both sides based on the reference line 150, the first variant portion 230 may be formed in two pieces.

In addition, since the first variant portion 230 in FIGS. 1 to 3 is formed as a point, the first variant portion 230 may be a first variant point 235 that divides the first facet 220 and the second facet 240. Hereinafter, the first variant portion 230 will be described as the first variant point 235.

However, the present disclosure is not necessarily limited thereto, and the first variant portion 230 could be formed as a gentle curve. In this case, the first variant point may be set based on a point where an imaginary line extending from one end of the first variant portion 230 in the extension direction of the first facet 220 and an imaginary line extending from the other end of the first variant portion 230 in the extension direction of the second facet 240 meet.

Meanwhile, the first variant point 235 may be formed between the coating tip 205 and the substrate tip 105. That is, an area between the substrate tip 105 and the coating tip 205 may include at least a portion of the second facet 240 and the first facet 220.

In addition, a gradient of the first facet 220 may be smaller than that of the second facet 240 based on the reference line 150. That is, an angle θ₁ formed on the coating tip 205 by the first facet 220 may be smaller than an angle θ₂ formed by meeting imaginary lines extending from the first variant point 235 in the extension direction of the second facet 240.

For example, referring to FIG. 2, the angle θ₁ formed on the coating tip 205 by the first facet 220 may be in range of 30° to 75°, preferably 35° to 70°, and more preferably 40° to 65°. The angle θ₂ formed by meeting the imaginary lines extending from the first variant point 235 in the extension direction of the second facet 240 may be in a range of 60° and 120°, preferably 70° to 110°, and more preferably 80° to 100°.

In addition, an angle θ₁₂ formed by meeting the imaginary line extending in the extension direction of the first facet 220 and the imaginary line extending in the extension direction of the second facet 240 may be in a range of 5° to 40°, and preferably may be in a range of 5° to 30°, and more preferably 10° to 30°.

Meanwhile, hereinafter, the gradient refers to the gradient formed by each facet based on the reference line 150.

Since the gradient of the first facet 220 of the razor blade 10 according to the embodiment of the present disclosure is smaller than that of the second facet 240, an area adjacent to the tip of the coating layer 200 may be formed with a relatively thin and sharp protrusion 210.

Since this protrusion 210 reduces the cutting force of the razor blade 10, it may be easier to cut hair. In addition, since the gradient of the second facet 240 is greater than that of the first facet 220, a thickness increase rate of the razor blade 10 is relatively high, so the skin irritation due to protrusion 210 may be minimized.

Meanwhile, the shape in the vicinity where the protrusion 210 is formed is described in more detail with reference to the partially enlarged view of FIG. 1, and assuming that a first circle C₁ passes through both the coating tip 205 and the two first variant points 235, a radius of the first circle C₁ may range from 0.005 to 0.15 micrometers, preferably from 0.01 to 0.1 micrometers, and more preferably from 0.02 to 0.07 micrometers.

In addition, assuming that a second circle C₂ passes through the first variant point 235 and points a and b on the first facet 220 and the second facet 240 corresponding to a point 0.01 micrometers away from the first variant point 235 in the direction of the reference line 150, a radius of the second circle C₂ may range from 0.003 to 0.15 micrometers, preferably from 0.005 to 0.11 micrometers, and more preferably from 0.01 to 0.08 micrometers.

A shape such as the protrusion 210 may be manufactured using an etching process and/or a coating process.

The etching process includes a dry etching process and a wet etching process. When the wet etching process is used, the process is carried out using a solution that selectively etches only thin film materials, so the protrusion 210 may be manufactured.

When using the dry etching process, it is possible to manufacture the protrusion using a chemical method of activating gas using plasma and then reacting with the thin film to remove the thin film or a physical method of partially removing a thin film by irradiating the thin film using an inert gas such as argon gas (Ar gas) and produce both the protrusion using both the chemical and physical methods.

When using the coating process, first, after a coating layer is formed using a conventional coating method, a protrusion 210 may be formed by being deposited on the coating layer with a higher bias voltage than the typically used in the conventional coating method. In this case, a first coating material and a second coating material may be the same material, for example, chromium carbon (CrC), but are not necessarily limited thereto. The first coating material may be CrC, and the second coating material may be chromium boride (CrB).

In addition, it is also possible to manufacture a shape such as the protrusion 210 using the above-described etching process and then proceed with coating using the above-described coating process.

The third facet 260 extends from the second facet 240. Accordingly, the third facet 260 may extend symmetrically to the reference line 150 from one end of the second facet 240.

An area where the second facet 240 and the third facet 260 meet, that is, an area where an extension of the second facet 240 ends and the extension of the third facet 260 begins, is defined as a second variant portion 250. Since the first facet 220 extends from the coating tip 205 to both sides and the second facet 240 extends from the first facet 220, the second variant portion 250 may also be formed in two like the first variant portion 230.

In addition, in FIGS. 1 to 3, since the second variant portion 250 is formed in a gentle curve, a second variant point 255 that distinguishes the second facet 240 and the third facet 260 may be set based on a point where an imaginary line extending from one end of the second variant portion 250 in the extension direction of the second facet 240 and an imaginary line extending from the other end of the second variant portion 250 in the extension direction of the third facet 260 meet.

However, the present disclosure is not necessarily limited thereto, and the second variant portion 250 could also be formed as a point like the first variant portion 230. In this case, the second variant portion 250 may become the second variant point 255.

The gradient of the third facet 260 may be smaller than that of the second facet 240. That is, the angle θ₂ formed by meeting the imaginary lines extending from the first variant point 235 in the extension direction of the second facet 240 may be greater than an angle θ₃ formed by meeting imaginary lines extending from the other end of the second variant portion 250 in the extension direction of the third facet 260.

For example, referring to FIG. 2, the angle θ₃ formed by meeting the imaginary lines extending from the other end of the second variant point 250 in the extension direction of the third facet 260 may be in a range of 7° to 45°, preferably 10° to 35°, and more preferably 13° to 25°.

In addition, an angle θ₂₃ formed by meeting an imaginary line extending from one end of the second variant portion 250 in the extension direction of the second facet 240 and an imaginary line extending from the other end of the second variant portion 250 in the extension direction of the third facet 260 may be in a range of 5° to 50°, preferably in a range of 10° to 45°, and more preferably 10° to 40°. Meanwhile, an angle θ₁₃ formed by meeting an imaginary line extending from one end of the first variant point 235 in the extension direction of the first facet 220 and the imaginary line extending from the other end of the second variant portion 250 in the extension direction of the third facet 260 may be in a range of 10° to 70°, preferably 20° to 60°, and more preferably 25° to 55°.

Since the gradient of the third facet 260 is smaller than that of the second facet 240, the thickness increase rate of the razor blade 10 is relatively reduced again, so the thickness of the razor blade 10 may not become excessively thick.

Hereinafter, the formation positions and thicknesses of the first facet 220, second facet 240, third facet 260, and substrate 100 will be described in more detail with reference to FIG. 3. Here, the thickness refers to the length when measured in a direction perpendicular to the reference line 150, for example, in the X-axis direction. In addition, the thickness of the coating layer 200 refers to a distance between symmetrical facets from T₀ to before the substrate tip 105 is formed, but from the point after the substrate tip 105 is formed, it refers to a distance from each facet to one side of the substrate 100 based on the reference line 150.

In addition, hereinafter, the point a micrometer away from the coating tip 205 in the direction of the reference line 150 is referred to as Tₐ, and the height of each facet refers to the distance between the start and end points of each facet measured along the direction of the reference line 150.

The first facet 220 may be formed from T_{0.03} to T_{0.15}, preferably from T_{0.04} to T_{0.12}, and more preferably from T_{0.05} to T_{0.1}.

The second facet 240 may be formed from T_{0.2} to T_{0.65}, preferably from T_{0.25} to T_{0.6}, and more preferably from T_{0.28} to T_{0.55}.

In addition, a ratio range of a height H₂ of the second facet 240 to a height H₁ of the first facet 220 may be in a range of 2 to 10, preferably 3 to 9, and more preferably 3 to 8.

Meanwhile, a distance L₁ in the direction of the reference line 150 from the coating tip 205 to the substrate tip 105 may be in a range of 0.1 to 0.6 micrometers, preferably 0.15 to 0.5 micrometers, and more preferably 0.2 to 0.4 micrometers.

A thickness W₁ of the coating layer 200 at the points where the first facet 220 and the second facet 240 meet, for example, at the first variant point 235, may be in a range of 0.035 to 0.16 micrometers, preferably 0.04 to 0.13 micrometers, and more preferably 0.05 to 0.11 micrometers. In addition, a thickness W₂ of the coating layer 200 at the point where the second facet 240 and the third facet 260 meet, for example, at the second variant point 255, may be in a range of 0.05 to 0.35 micrometers, preferably 0.08 to 0.3 micrometers, and more preferably 0.1 to 0.25 micrometers.

Meanwhile, when divided into 0.05 micro units from T_{0.05} to T_{0.5}, the thickness range at each position is shown in Table 1 below. The thickness in Table 1 includes not only the coating layer 200 but also the thickness of the substrate 100, and refers to the distance in the X-axis direction between symmetrical facets regardless of the point at which the substrate tip 105 is formed.

TABLE 1

| | T_{0.05} | T_{0.1} | T_{0.15} | T_{0.2} | T_{0.25} | T_{0.3} | T_{0.35} | T_{0.4} | T_{0.45} | T_{0.5} |
|---|---|---|---|---|---|---|---|---|---|---|
| Thickness | 0.02~ | 0.09~ | 0.135~ | 0.165~ | 0.23~ | 0.31~ | 0.34~ | 0.39~ | 0.41~ | 0.45~ |
| Range (μm) | 0.16 | 0.24 | 0.335 | 0.465 | 0.53 | 0.61 | 0.7 | 0.75 | 0.81 | 0.85 |
| Preferable | 0.025~ | 0.105~ | 0.155~ | 0.215~ | 0.290~ | 0.360~ | 0.390~ | 0.440~ | 0.460~ | 0.500~ |
| Thickness Range | 0.140 | 0.220 | 0.315 | 0.415 | 0.490 | 0.560 | 0.650 | 0.700 | 0.760 | 0.800 |
| More Preferable | 0.040~ | 0.115~ | 0.185~ | 0.235~ | 0.310~ | 0.380~ | 0.430~ | 0.480~ | 0.510~ | 0.550~ |
| Thickness Range | 0.110 | 0.190 | 0.285 | 0.395 | 0.460 | 0.540 | 0.610 | 0.660 | 0.710 | 0.750 |

However, in Table 1, preferably, the thickness range at T_{0.05} may be from 0.025 to 0.14 micrometers, the thickness range at T_{0.1} may be from 0.105 to 0.22 micrometers, the thickness range at T_{0.15} may be from 0.155 to 0.315 micrometers, the thickness range at T_{0.2} may be from 0.215 to 0.415 micrometers, the thickness range at T_{0.25} may be from 0.29 to 0.49 micrometers, the thickness range at T_{0.3} may be in a range of 0.36 to 0.56 micrometers, the thickness range at T_{0.35} may be in a range of 0.39 to 0.65 micrometers, the thickness range at T_{0.4} may be in a range of 0.44 to 0.7 micrometers, the thickness range at T_{0.45} may be in a range of 0.46 to 0.76 micrometers, and the thickness range at T_{0.5} may be in a range of 0.5 to 0.8 micrometers.

In addition, based on the thickness at the first variant point 235, the ratio range with the thickness at T_{0.1} may be in a range of 1.7 to 2.9, the ratio range with the thickness at T_{0.2} may be in a range of 3.5 to 6.0, the ratio range with the thickness at T_{0.3} may be in a range of 5.7 to 8.2, the ratio range with the thickness at T_{0.4} may be in a range of 7.2 to 10, and the ratio range with the thickness at T_{0.5} may be in a range of 8.2 to 11.4.

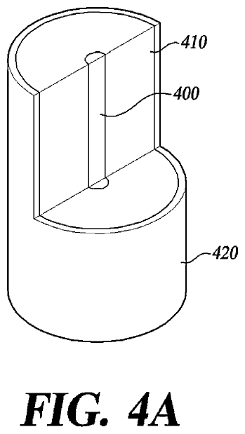

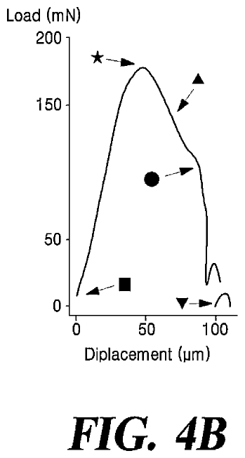

FIGS. 4A and 4B are diagrams illustrating hair and results of a cutting force test on the hair.

Referring to FIGS. 4A and 4B, in order to accurately measure the cutting force, a fixing unit (not illustrated) is installed on a side opposite to the side where the razor blade approaches based on the hair to prevent the hair from tilting as the cutting progresses.

Since there is no fixing unit during actual shaving, the hair is tilted in the direction of the razor blade from the moment the razor blade contacts the hair. In this case, the cutting force increases because the force from the razor blade is not fully transmitted to the hair. Therefore, for the efficient shaving, it is important to be able to cut the hair more quickly and with less force from the moment the razor blade contacts the hair before the hair tilts further.

Meanwhile, FIGS. 4A and 4B are diagrams extracted from the paper G Roscioli, How hair deforms steel, Aug. 6, 2020, Science, Vol. 369, Issue 6504, pp. 689-694 (DOI: 10.1126/science.aba9490).

Referring to FIG. 4A, human hair has a thickness of about 100 micrometers on average, although it varies from person to person. In addition, the hair is largely divided into three layers: a medulla layer 400, a cortex layer 410, and a cuticle layer 420. At the outermost layer, the relatively hardest cuticle layer 420 is configured to protect the inner layer. Therefore, when cracks are quickly generated in the cuticle layer 420 with less force, the cutting force may be greatly reduced.

As described above, the razor blade 10 according to an embodiment of the present disclosure has a relatively thin and sharp protrusion 210 formed at the tip area, so that cracks may be generated in the cuticle layer 420 more quickly and with less force.

Referring to FIG. 4B, the force required for cutting increases until approximately half of the hair is cut. After about half of the hair has been cut, the cutting could be performed with less force, so the hair may be cut effectively even with a relatively thick razor blade.

Meanwhile, in the razor blade 10 according to the embodiment of the present disclosure, the protrusion 210 of the razor blade 10 is formed in an area ranging from 0.03 to 0.15 micrometers in the direction of the reference line 150 from the tip and the area after the protrusion 210 is formed is configured to greatly increase the thickness.

Therefore, the protrusion 210 is involved in crack generation in the cuticle layer 420, that is, the initial cutting of the hair, and after a certain portion of the cutting is performed, the razor blade with a relatively large thickness penetrates into the hair. Accordingly, the size of the crack generated by protrusion 210 may increase, and as the crack increases in size, the hair may be cut with less force. In addition, after the cutting, the contact area of the skin with the relatively thick razor blade increases, thereby reducing the skin irritation.

Meanwhile, the cutting force test results showed that single hair cutting force (SHCF) of the razor blade 10 according to an embodiment of the present disclosure was reduced by about 7.8% compared to the SHCF of the conventional razor blade.

Here, the SHCF is the force required to cut a single of hair while the razor blade moves at a constant speed, and refers to the maximum value of force measured when cutting the hair. When the SHCF is low, less force is required to cut the hair, so there is less tugging of the hair during the shaving and a more comfortable shave is possible.

TABLE 2

| | | After | After |
|---|---|---|---|
| | | cutting | performing |
| | Initial | wool felt | shaving test |
| | value | 500 times | 4 times |
| Average protrusion | 48.84 nm | 41.6 nm | 48.03 nm |
| height | (3.30) | (5.34) | (3.41) |
| Rate of change in | — | −14.82% | −1.66% |
| protrusion height | | | |

Table 2 above shows the average protrusion height and the rate of change before and after the high-speed cutting is performed on wool felt 500 times and before and after the shaving test is performed 4 times.

It can be confirmed that the protrusion 210 did not break away even after the above cutting and shaving tests were performed, and that it generally maintains its initial shape.

TABLE 3

After cutting artificial hair 800 times

| | Increase rate | Rate of change |
|---|---|---|
| | of cutting force | in protrusion height |
| Conventional razo | 4.21% | — |
| blade | | |
| Razor blade of | 5.82% | −6.98% |
| present disclosure | | |

Table 3 above shows the increase rate of the cutting force and the rate of change in protrusion height before and after shaving for artificial hair (PVC) with a thickness of about 80 micrometers.

In this case, the increase rate of the cutting force was calculated as the increase in the average cutting force for 751 to 800 cuts compared to the average cutting force for first 101 to 150 cuts, and the rate of change in protrusion height was calculated as the decrease in protrusion height after 800 cuts compared to the initial protrusion height before the cutting.

For the conventional razor blade, the average cutting force for the first 101 to 150 cuts was measured to be 9.83 gf, and the average cutting force for 751 to 800 cuts was measured to be 10.25 gf, so the increase rate of the cutting force appeared as about 4.21%.

For the razor blade of the present disclosure, the average cutting force for the first 101 to 150 cuts was measured to be 9.19 gf, and the average cutting force for 751 to 800 cuts was measured to be 9.72 gf, so the increase rate of the cutting force appeared as about 5.82%.

Meanwhile, for the razor blade 10 of the present disclosure, the protrusion 210 did not break even after cutting 800 times, and the change rate in height was only −6.98%, so the degree of wear was not significant.

In addition, in terms of the increase rate of the cutting force, the razor blade 10 of the present disclosure increased by about 5.82% compared to the conventional razor blade which increased by about 4.21%, so the difference in increase rate was not large, and the razor blade 10 of the present disclosure still showed a cutting force that was smaller than that of the conventional razor blade even after 800 cuts.

Therefore, the razor blade 10 according to the embodiment of the present disclosure includes the protrusion 210 and has little difference in durability compared to the conventional razor blade.

Although exemplary embodiments of the present disclosure have been described for illustrative purposes, those skilled in the art could appreciate that various modifications, additions, and substitutions are possible, without departing from the defining features by the embodiments. Therefore, the embodiments of the present disclosure are intended for explanatory purposes, and the scope of the technical ideas of the embodiments are not limited by these illustrations The scope of protection for the embodiments should be interpreted based on the claims below, and all technical ideas within the equivalent scope would be intended to be included within the rights of the embodiments.

### REFERENCE NUMERALS

10: razor blade, 100: substrate, 105: substrate tip, 120: substrate edge, 150: reference line, 200: coating layer, 205: coating tip, 210: protrusion, 220: first facet, 230: first variant portion, 235: first variant point, 240: second facet, 250: second variant portion, 255: second variant point, 260: third facet, 400: medulla layer, 410: cortex layer, 420: cuticle layer

What is claimed is:

1. A razor blade, comprising:
a substrate including a substrate edge comprising a substrate tip formed at an end portion thereof; and
a coating layer disposed on the substrate and comprising a coating tip formed at the end portion thereof,
wherein the coating layer includes:
a pair of first facets extending from the coating tip; and
a pair of second facets extending from the pair of first facets, and
wherein a gradient of the first facet is smaller than that of the second facet based on a reference line passing through the substrate tip and the coating tip.

2. The razor blade of claim 1, wherein an area between the substrate tip and the coating tip includes the first facet and at least a portion of the second facet.

3. The razor blade of claim 1, wherein in response to a point a micrometer away from the coating tip in a direction of the reference line being Tₐ, the first facet is formed from the coating tip to a point (T_{0.03} to T_{0.15}) from 0.03 micrometers to 0.15 micrometers away in the direction of the reference line.

4. The razor blade of claim 1, wherein a thickness of the coating layer at a point where the first facet and the second facet meet is in a range of 0.035 micrometers to 0.16 micrometers.

5. The razor blade of claim 1, wherein in response to a point a micrometer away from the coating tip in a direction of the reference line being Tₐ, the second facet is formed from the coating tip to a point (T_{0.2} to T_{0.65}) from 0.2 micrometers to 0.65 micrometers away in the direction of the reference line.

6. The razor blade of claim 1, wherein the coating layer includes a pair of third facets extending from the pair of second facets, and
wherein a gradient of the third facet is smaller than that of the second facet based on the reference line.

7. The razor blade of claim 6, wherein a thickness of the coating layer at a point where the second facet and the third facet meet is in a range of 0.05 micrometers to 0.35 micrometers.

8. The razor blade of claim 6, wherein in the direction of the reference line, a ratio of a distance from the coating tip to a point where the first facet and the second facet meet to a distance from the coating tip to a point where the second facet and the third facet meet is in a range of 2 to 10.

9. The razor blade of claim 1, wherein an angle formed at the coating tip by the first facet is in a range of 30° to 75°.

10. The razor blade of claim 1, wherein an angle formed by meeting imaginary lines extending from points where the pair of first facets and the pair of second facet meets in an extension direction of the pair of second facets is in a range of 60° to 120°.

11. The razor blade of claim 1, wherein in response to a point a micrometer away from the coating tip in a direction of the reference line being Tₐ, the substrate tip is formed from the coating tip to a point (T_{0.1} to T_{0.6}) from 0.1 micrometers to 0.6 micrometers away in the direction of the reference line.
